(19) United States
(12) Patent Application Publication
(10) Pub. No.: US 2024/0293805 A1
(43) Pub. Date: Sep. 5, 2024

(54) INDUCTIVELY HEATED NOX ADSORBER

(71) Applicant: BASF Corporation, Florham Park, NJ (US)

(72) Inventors: David M. Youngren, Union, NJ (US); Xiaofan Yang, Iselin, NJ (US); Xinyi Wei, Iselin, NJ (US); Matthew T. Caudle, Iselin, NJ (US)

(21) Appl. No.: 18/030,267

(22) PCT Filed: Oct. 5, 2021
(86) PCT No.: PCT/US2021/071714

§ 371 Date: Apr. 4, 2023

Related U.S. Application Data
(60) Provisional application No. 63/087,680, filed on Oct. 5, 2020.

(51) Int. Cl. B01J 29/072; B01D 53/94; B01J 35/33; B01J 35/56

(52) U.S. Cl. CPC B01J 29/072; B01D 53/945; B01J 35/33; B01J 35/56; B01D 2255/206; B01D 2255/207; B01D 2255/50; B01D 2255/91; B01D 2255/9155; B01D 2257/404; B01D 2258/012; B01D 2258/014; B01D 2258/018

(57) ABSTRACT

The application provides articles, systems, and methods for adsorbing and desorbing nitrogen oxides (NOₓ) at desired temperatures. The catalytic article comprises a NOₓ adsorber composition comprising a platinum group metal (PGM) component disposed on or impregnated in a support material, and a substrate, wherein the catalytic article further comprises a magnetic material capable of inductive heating in response to an applied alternating electromagnetic field. The catalytic article further comprises a conductor associated therewith for receiving current and generating an alternating electromagnetic field in response thereto, wherein the conductor is positioned such that the generated alternating electromagnetic field is applied to at least a portion of the magnetic material. This field can inductively heat the magnetic material to heat the NOₓ adsorber composition to desorb the NOₓ from the NOₓ adsorber composition.

This application claims the benefit of priority of U.S. Provisional Application No. 63/087,680, filed Oct. 5, 2020, the contents of which are incorporated by reference herein in their entirety.

The present disclosure relates to compositions for use in treating engine effluent, methods for the preparation and use of such compositions, and catalyst articles and systems employing such compositions.

Emissions of diesel engines include particulate matter (PM), nitrogen oxides (NOₓ), unburned hydrocarbons (HC), and carbon monoxide (CO). NOₓ is a term used to describe various chemical species of nitrogen oxides, including nitrogen monoxide (NO) and nitrogen dioxide (NO₂), among others. The two major components of exhaust particulate matter are the soluble organic fraction (SOF) and the soot fraction. The SOF condenses on the soot in layers, and is generally derived from unburned diesel fuel and lubricating oils. The SOF can exist in diesel exhaust either as a vapor or as an aerosol (i.e., fine droplets of liquid condensate), depending on the temperature of the exhaust gas. Soot is predominately composed of particles of carbon. The HC content of exhaust can vary depending on engine type and operating parameters, but typically includes a variety of short-chain hydrocarbons such as methane, ethane, propane, and the like, as well as longer-chain fuel-based hydrocarbons.

Various treatment methods have been used for the treatment of NOₓ-containing gas mixtures to decrease atmospheric pollution. Catalysts used to treat the exhaust of internal combustion engines are less effective during periods of relatively low temperature operation, such as the initial cold-start period of engine operation, because the engine exhaust is not at a temperature sufficiently high for efficient catalytic conversion to occur. For example, this occurs for the downstream catalyst components, especially those placed after a high-thermal mass filter, such as an SCR catalyst, which can take several minutes to reach a suitable operating temperature.

Use of on-board, electric power to heat a catalyst article during start-up conditions bas been suggested. Various methods include, e.g., preheating gas via resistive heating of a heating element (see, e.g., U.S. Pat. Nos. 8,479,496 to Gonze et al.; 10,690,031 to Barrientos Betancourt et al.; 6,112,519 to Shimasaki et al.; and 8,156,737 to Gonze et al.); direct resistive heating of a catalyst substrate (see, e.g., US Pat. App. Publ. No. US2011/0072805 and U.S. Pat. No. 10,677,127 to Achenbach et al.); and resistive heating of conductive elements in a ceramic substrate (see, e.g., U.S. Pat. Nos. 10,731,534 to Stiglmair et al.; 10,681,779 to Noro; 9,845,714 to Mori et al., 8,784,741 to Yoshioka et al., and 8,329,110 to Kinoshita et al.). In one instance, the heat is generated by the electric heater, e.g., electric wires wrapped outside the catalyst substrate, a heated grid, or a metallic substrate itself serving as the heating element. Several challenges to successful commercialization of such systems exist, including the relatively high energy consumption required and the relatively low heating efficiency due to the need to first heat the catalyst substrate. In addition, most electric heating designs in the art use metallic substrates and are not compatible with the more widely-adopted ceramic substrates used as a catalyst carrier in many systems. Various engine management strategies have also been suggested to address decreased efficiency during the initial cold-start period (see, e.g., U.S. Pat. Nos. 10,138,781 to Host et al.; 10,082,047 to Joshi et al.; 9,506,426 to Remes; 10,273,906 to McQuillen et al.; 6,657,315 to Peters et al.; 8,955,473 to Zhang; and 9,382,857 to Glugla et al.).

Induction heating of catalyst bodies has been explored recently (see, e.g., U.S. Pat. Nos. 9,488,085; 10,132,221; and 10,352,214 to Crawford and Douglas). Current technology employs electrically conductive elements embedded in a ceramic substrate, which are heated by induction of eddy currents in the conductor. Non-contact induction heating of catalysts has several advantages. There is no need for a direct electrical connection to the catalyst body. The incorporate a ceramic support for the catalyst washcoat. But the current technology suffers from complexity in manufacture (e.g., melding ceramic/metallic interfaces) and inhomogeneity in the distribution of heat.

There is a continuing need in the art to reduce tailpipe emissions of gaseous pollutants from gasoline or diesel engines, particularly breakthrough emissions (e.g., of NOₓ) that occur, particularly during cold start of the engine.

The present disclosure provides catalytic articles, systems, and associated methods adapted to facilitate inductive heating of a catalytic material. In some embodiments, the disclosure is directed to catalytic articles trapping (adsorbing) and desorbing nitrogen oxides (NOₓ) therefrom under designated conditions, thereby providing control of the adsorption and/or desorption of from the catalytic article. Such a catalytic article can, for example, trap NOₓ at low temperatures and hold the trapped NOₓ until some designated event (e.g., until a certain temperature is reached, such as that temperature at which a downstream SCR catalyst is understood to be active). In this way, it may be possible to avoid significant passage of NOₓ across a downstream SCR that is not at a high enough temperature to promote reduction of the NOₓ.

In some embodiments, the present disclosure is provided a method for adsorbing and desorbing nitrogen oxides (NOₓ) from a catalyst article for treating an exhaust gas stream from a diesel engine or a lean-bum gasoline engine, comprising: contacting the exhaust gas stream with a catalytic article, the catalytic article comprising a NOₓ adsorber composition with a platinum group metal (PGM) component disposed on or impregnated in a support material, and a substrate, wherein the NOₓ adsorber composition is effective for storing the NOₓ at temperatures below 225° C., and wherein the catalytic article comprises a magnetic material capable of inductive heating in response to an applied alternating electromagnetic field, wherein the catalytic article further has a conductor associated therewith for receiving current and generating an alternating electromagnetic field in response thereto, the conductor positioned such that the generated alternating electromagnetic field is applied to at least a portion of the magnetic material: intermittently energizing the conductor by passing current therethrough to generate an alternating electromagnetic field and inductively heating the magnetic material to heat the NOₓ adsorber composition to a temperature greater than 225° C. and desorb the NOₓ from the NOₓ adsorber composition.

In some embodiments, the conductor is adapted with a feedback control and wherein the intermittent energizing occurs only if the substrate has a temperature below 225° C. In some embodiments, the intermittent energizing is done on demand.

The disclosed method, in some embodiments, further comprises contacting the exhaust gas stream with a selective catalytic reduction (SCR) catalyst composition downstream of the NOₓ adsorber composition. In some embodiments, the NOₓ adsorber composition and the SCR catalyst composition are, for example, on the same substrate or they are on separate substrates. The disclosed method, in some embodiments, further comprises monitoring the temperature of the SCR catalyst composition, wherein the intermittent energizing occurs when the temperature of the SCR catalyst composition rises above a pre-determined temperature. In some embodiments, this pre-determined temperature varies. In some embodiments, the pre-determined temperature is about 180° C. and in some embodiments, the pre-determined temperature is about 200° C.

In some embodiments, the method further comprises maintaining the NOₓ adsorber composition at a temperature greater than 225° C. wherein the SCR catalyst composition is above the pre-determined temperature. The method, in some embodiments, further comprises removing the current when the SCR catalyst composition is below the pre-determined temperature.

In some embodiments, the disclosure provides a system for treating an exhaust gas stream from a diesel engine or a lean-burn gasoline engine, comprising: a catalyst article comprising a NOₓ adsorber composition at a temperature below 225° C., comprising a platinum group metal (PGM) component disposed on or impregnated in a support material, and a substrate, wherein the NOₓ adsorber composition is effective for storing the NOₓ at temperatures below 225° C., and wherein the catalytic article comprises a magnetic material for inductive heating in response to an applied alternating electromagnetic field; a conductor for receiving current and generating an alternating electromagnetic field in response thereto, the conductor is positioned wherein the generated alternating electromagnetic field is applied to at least a portion of the magnetic material; and an SCR catalyst composition downstream of the NOₓ adsorber composition.

These and other features, aspects, and advantages of the disclosure will be apparent from a reading of the following detailed description together with the accompanying drawings, which are briefly described below. The disclosed subject matter includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed subject matter, in any of its various aspects and embodiments, should be viewed as intended to be combinable unless the context clearly dictates otherwise. Other aspects and advantages of the disclosed subject matter will become apparent from the following.

### BRIEF DESCRIPTION OF THE DRAWINGS

In order to provide an understanding of embodiments of the disclosure, reference is made to the appended drawings, which are not necessarily drawn to scale, and in which reference numerals refer to components of exemplary embodiments of the disclosed subject matter. The drawings are exemplary only, and should not be construed as limiting the disclosure.

FIG. 1 is a perspective view of a honeycomb-type substrate which may comprise a catalyst composition as described herein;

FIG. 2 is a partial cross-sectional view enlarged relative to FIG. 1 and taken along a plane parallel to the end faces of the carrier of FIG. 1, which shows an enlarged view of a plurality of the gas flow passages shown in FIG. 1;

FIG. 3A is a partial cross-sectional view of a catalyst substrate perpendicular to the channel direction showing the channel opening 10, the substrate wall 12, and magnetic particles 20 dispersed in the wall;

FIG. 3B is a partial cross-sectional view of a catalyst substrate perpendicular to the channel direction showing the channel opening 10, the substrate wall 12. and magnetic particles 20 dispersed in pores of the substrate material;

FIG. 4 shows a schematic depiction of an embodiment of a catalytic article, functionalized to allow for inductive heating as disclosed herein; and

FIG. 5 shows a schematic depiction of an embodiment of an emission treatment system in which a catalytic article as disclosed herein is employed.

The present disclosure now will be described more fully hereinafter. Although the subject matter herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present subject matter include modifications and variations that are within the scope of the appended claims and their equivalents. It is to be understood that the disclosure is not limited to the details of construction or process steps set forth in the following description. The subject matter is capable of other embodiments and of being practiced or being carried out in various ways. Like numbers refer to like elements throughout. As used in this specification and the claims, the singular forms “a,” “an,” and “the” include plural referents unless the context clearly dictates otherwise.

The present disclosure generally provides catalysts, systems, and associated methods involving control of the adsorption and/or desorption of nitrogen oxides (NOₓ) from the catalytic article. For example, the adsorption and/or desorption of NOₓ is controlled by intentionally modifying the temperature of the catalyst article and, particularly, the temperature of a catalyst composition in the form of a washcoat associated with a substrate. The referenced temperature control can be provided, e.g., by employing a catalytic article that is responsive to application of electrical current, wherein the electrical current can operate to effectively inductively heat the washcoat (catalyst composition) of the catalytic article when desorption of NOₓ is desired (e.g., when a downstream selective catalytic reduction (SCR) catalyst has reached sufficient temperature for suitable activity).

The catalytic article generally must comprise at least one component that is responsive to application of an electric current, such that the composition can be characterized as being “heatable” (e.g., inductively heatable) upon application of the current. To provide this capability, the catalyst composition may, in some embodiments, comprise a mixture of catalytically active particles and a magnetic material capable of inductive heating in response to an applied alternating electromagnetic field. Certain components that can be employed within the catalyst composition to serve this function which include, but are not limited to, those set forth in International Patent Application Publication No. WO 2017/195107 to BASF Corp., which is incorporated herein by reference in its entirety. As another alternative, the catalytic article may comprise magnetic material within the substrate, e.g., as described in U.S. Prov. Pat. Appl. No. 63/087,640 to Caudle et al., filed Oct. 5, 2020, which is incorporated herein by reference in its entirety.

The use of inductive heating of a magnetic material associated with a catalytic article can be an efficient means to direct heat to the catalyst composition of the catalytic article. The “magnetic material” is chosen from ferromagnetic, ferrimagnetic, and paramagnetic materials. The form of the magnetic material associated with the catalytic article according to the present disclosure is chosen from a particulate form, such as including nanoparticle magnetic materials denoted as superparamagnetic materials or the form of nanowires, nanotubes, a sheet, or other shape.

### Definitions

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All 5 numeric values are modified by the term “about” whether or not explicitly indicated. Numeric values modified by the term “about” include the specific identified value. For example “about 5.0” includes 5.0.

The term “abatement” means a decrease in the amount, caused by any means.

“AMOₓ” refers to a selective ammonia oxidation catalyst, which is a catalyst comprising one or more metals (typically Pt, although not limited thereto) and a selective catalytic reduction (SCR) catalyst suitable to convert ammonia to nitrogen.

The term “associated” means for instance “equipped with”, “connected to” or in “communication with”, for example “electrically connected” or in “fluid communication with” or otherwise connected in a way to perform a function. The term “associated” may mean directly associated with or indirectly associated with, for instance through one or more other articles or elements.

“Average particle size” is synonymous with D50, meaning half of the population of particles has a particle size above this point, and half below. Particle size refers to primary particles. Particle size may be measured by laser light scattering techniques, with dispersions or dry powders, for example according to ASTM method D4464. D90 particle size distribution indicates that 90% of the particles (by number) have a Feret diameter below a certain size as measured by Scanning Electron Microscopy (SEM) or Transmission Electron Microscopy (TEM) for submicron size particles; and a particle size analyzer for the support-containing particles (micron size).

The term “catalyst” refers to a material that promotes a chemical reaction. The catalyst includes the “catalytically active species” and the “support” that carries or supports the active species. For example, zeolites are supports for palladium active catalytic species. Likewise, refractory metal oxide particles may be a support for platinum group metal catalytic species. The catalytically active species are also termed “promoters” as they promote chemical reactions. For instance, a present palladium-containing rare earth metal component may be termed a Pd-promoted rare earth metal component. A “promoted rare earth metal component” refers to a rare earth metal component to which catalytically active species are intentionally added.

The term “catalytic article” in the disclosure means an article comprising a substrate having a catalyst coating composition.

The term “configured” as used in the description and claims is intended to be an open-ended term as are the terms “comprising” or “containing.” The term “configured” is not meant to exclude other possible articles or elements. The term “configured” may be equivalent to “adapted.”

“CSF” refers to a catalyzed soot filter, which is a wall-flow monolith. A wall-flow filter comprises alternating inlet channels and outlet channels, wherein the inlet channels are plugged on the outlet end and the outlet channels are plugged on the inlet end. A soot-carrying exhaust gas stream entering the inlet channels is forced to pass through the filter walls before exiting from the outlet channels. In addition to soot filtration and regeneration, a CSF may carry oxidation catalysts to oxidize CO and HC to CO₂ and H₂O, or oxidize NO to NO₂ to accelerate the downstream SCR catalysis or to facilitate the oxidation of soot particles at lower temperatures. An SCR catalyst composition can also coated directly onto a wall-flow filter, which is called SCRoF.

“DOC” refers to a diesel oxidation catalyst, which converts hydrocarbons and carbon monoxide in the exhaust gas of a diesel engine. Typically, a DOC comprises one or more platinum group metals such as palladium and/or platinum; a support material such as alumina; a zeolite for HC storage; and optionally, promoters and/or stabilizers.

As used herein, the phrase “emission treatment system” refers to a combination of two or more catalyst components, for example, a combination of an LNT-LT-NA as disclosed herein and one or more additional catalyst components which may be, for example, a CSF, a DOC, or a selective catalytic reduction (SCR) catalytic article.

In general, the term “effective” means for example from about 35% to 100% effective, for instance from about 40%, about 45%, about 50% or about 55% to about 60%, about 65%, about 70%, about 75%, about 80%, about 85%, about 90% or about 95%, regarding the defined catalytic activity or storage/release activity, by weight or by moles.

The term “exhaust stream” or “exhaust gas stream” refers to any combination of flowing gas that may contain solid or liquid particulate matter. The stream comprises gaseous components and is for example exhaust of a lean burn engine, which may contain certain non-gaseous components such as liquid droplets. solid particulates and the like. The exhaust gas stream of a combustion engine typically further comprises combustion products (CO₂ and H₂O). products of incomplete combustion (carbon monoxide (CO) and hydrocarbons (HC)). oxides of nitrogen (NOₓ), combustible and/or carbonaceous particulate matter (soot), and un-reacted oxygen and nitrogen. As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles. also referred to as “washcoated monoliths.”

The term “functional article” in the disclosure means an article comprising a substrate having a functional coating composition disposed thereon, in particular a catalyst and/or sorbent coating composition.

As used herein, “impregnated” or “impregnation” refers to permeation of the catalytic material into the porous structure of the support material.

The terms “on” and “over” in reference to a coating layer may be used synonymously. The term “directly on” means in direct contact with. The disclosed articles are referred to in certain embodiments as comprising one coating layer “on” a second coating layer, and such language is intended to encompass embodiments with intervening layers, where direct contact between the coating layers is not required (i.e., “on” is not equated with “directly on”).

As used herein, the term “promoted” refers to a component that is intentionally added to the rare earth metal component, as opposed to impurities inherent in the rare earth metal component. “Promoters” are metals that enhance activity toward a desired chemical reaction or function.

As used herein, the term “selective catalytic reduction” (SCR) refers to the catalytic process of reducing oxides of nitrogen to dinitrogen (N₂) using a nitrogenous reductant.

As used herein, the terms “nitrogen oxides” or “NOₓ” designate the oxides of nitrogen, such as NOₓ NO₂ or N₂O.

As used herein, the term “stream” broadly refers to any combination of flowing gas that may contain solid or liquid particulate matter. The term “gaseous stream” or “exhaust gas stream” means a stream of gaseous constituents, such as the exhaust of a combustion engine, which may contain entrained non-gaseous components such as liquid droplets, solid particulates, and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and un-reacted oxygen and nitrogen.

“Substantially free” means “little or no” or “no intentionally added” and also having only trace and/or inadvertent amounts. For instance, in certain embodiments, “substantially free” means less than 2 wt. % (weight %), less than 1.5 wt. %, less than 1.0 wt. %, less than 0.5 wt. %, 0.25 wt. % or less than 0.01 wt. %, based on the weight of the indicated total composition.

As used herein, the term “substrate” refers to the monolithic material onto which the catalyst composition, that is, catalytic coating, is disposed, typically in the form of a washcoat. In one or more embodiments, the substrates comprise flow-through monoliths and monolithic wall-flow filters. Flow-through and wall-flow substrates are also taught, for example, in International Application Publication No. W02016/070090, which is incorporated herein by reference. A washcoat is formed by preparing a slurry comprising a specified solids content (e.g., 30-90% by weight) of catalyst in a liquid, which is then coated onto a substrate and dried to provide a washcoat layer. Reference to “monolithic substrate” means a unitary structure that is homogeneous and continuous from inlet to outlet. A washcoat is formed by preparing a slurry containing a certain solid content (e.g., 20%-90% by weight) of particles in a liquid vehicle, which is then coated onto a substrate and dried to provide a washcoat layer.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

As used herein, the term “washcoat” has its usual meaning in the art of a thin, adherent coating of a catalytic or other material applied to a substrate material, such as a honeycomb-type substrate, which is sufficiently porous to permit the passage of the gas stream being treated. As used herein and as described in Heck, Ronald and Farrauto, Robert, Catalytic Air Pollution Control. New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example particle size or crystallite phase) and/or may differ in the chemical catalytic functions.

As used herein, “weight percent (wt. %),” if not otherwise indicated, is based on an entire composition free of any volatiles, that is, based on dry solids content. Unless otherwise indicated, all parts and percentages are by weight.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods. All U.S. patent applications, pre-grant publications and patents referred to herein are hereby incorporated by reference in their entireties.

### NON-LIMITING EXAMPLE EMBODIMENTS

Without limitation, some embodiments of the disclosure include:
1. A method for adsorbing and desorbing nitrogen oxides (NOₓ) from a catalyst article adapted for treating an exhaust gas stream from a diesel engine or a lean-bum gasoline engine, comprising:
   contacting the exhaust gas stream with a catalytic article, the catalytic article comprising a NOₓ adsorber composition at a temperature below 225° C., comprising a platinum group metal (PGM) component disposed on or impregnated in a support material, and a substrate, wherein the NOₓ adsorber composition is effective for storing the NOₓ at temperatures below 225° C., and
   wherein the catalytic article comprises a magnetic material capable of inductive heating in response to an applied alternating electromagnetic field, and
   wherein the catalytic article has a conductor associated therewith for receiving current and generating an altemating electromagnetic field in response thereto, the conductor positioned such that the generated alternating electromagnetic field is applied to at least a portion of the magnetic material; intermittently energizing the conductor by passing current therethrough to generate an alternating electromagnetic field and inductively heat the magnetic material in order to heat the NOₓ adsorber composition to a temperature greater than 225° C. and desorb the NOₓ from the NOₓ adsorber composition.
2. The method of embodiment 1, wherein the conductor is adapted with a feedback control and wherein the intermittent energizing occurs only if the substrate has a temperature below 225° C.
3. The method of embodiment 1, further comprising contacting the exhaust gas stream with a selective catalytic reduction (SCR) catalyst composition downstream of the NOₓ adsorber composition.
4. The method of embodiment 3, wherein the NOₓ adsorber composition and the SCR catalyst composition are on the same substrate.
5. The method of embodiment 3, wherein the NOₓ adsorber composition and the SCR catalyst composition are on separate substrates.
6. The method of any one of embodiments 3-5, further comprising: monitoring the temperature of the SCR catalyst composition,
   wherein the intermittent energizing occurs when the temperature of the SCR catalyst composition rises above a pre-determined temperature.
7. The method of embodiment 6, wherein the pre-determined temperature is about 180° C. or about 200° C.
8. The method of any one of embodiments 6-7, further comprising maintaining the NOₓ adsorber composition at a temperature greater than 225° C. so long as the SCR catalyst composition is above the pre-determined temperature.
9. The method of embodiment 8, further comprising removing the current when the SCR catalyst composition is below the pre-determined temperature.
10. A system for treating an exhaust gas stream from a diesel engine or a lean-burn gasoline engine, comprising:
   a catalyst article comprising a NOₓ adsorber composition at a temperature below 225° C., comprising a platinum group metal (PGM) component disposed on or impregnated in a support material, and a substrate, wherein the NOₓ adsorber composition is effective for storing the NOₓ at temperatures below 225° C., and
   wherein the catalytic article comprises a magnetic material capable of inductive heating in response to an applied alternating electromagnetic field, and
   a conductor for receiving current and generating an alternating electromagnetic field in response thereto, the conductor positioned such that the generated alternating electromagnetic field is applied to at least a portion of the magnetic material, and
   an SCR catalyst composition downstream of the NOₓ adsorber composition.
11. The system of embodiment 10, wherein the NCR adsorber composition and the SCR catalyst composition are on the same substrate.
12. The system of embodiment 11, wherein the NCR adsorber composition and the SCR catalyst composition are on separate substrates.

### Magnetic Component

In some embodiments, the size of the magnetic material (e.g., particle size) may directly impact the type of magnetic materials that can be used. In other words, the magnetic particles in some embodiments can generally comprise any material, so long as the particles are above a certain size threshold (suitable to provide the desired effect). Although the particles can, in some embodiments, be formed at least in part of a conductive material, in some embodiments, particles comprising non-conductive materials (e.g., particles consisting essentially of non-conductive materials) are preferred. In some embodiments, any material that can be inductively coupled via eddy currents (e.g., including metal particles, wire fragments, and other metal-containing materials) can be used for this purpose.

The form (e.g., shape and size) of magnetic material particles can vary. The particles. in some embodiments, are nanoparticles, although they are not limited thereto. As such, in some embodiments, the average particle size is about 100 nm or less (e.g., from about 1 nm to about 100 nm). In some embodiments, the particles are at the smaller end of this range. For example, in some embodiments, the average particle size is about 60 nm or less (e.g., from about 1 nm to about 60 nm), or about 50 nm or less (e.g., from about 1 nm to about 50 nm). In some embodiments, the particles are at the larger end of this range, e.g., about 60 nm or more (e.g., from about 60 nm to about 100 nm or from about 80 nm to about 100 nm). In some embodiments, the particles are even larger, e.g., about 100 nm or greater (e.g., from about 100 nm to about 500 nm, from about 100 nm to about 400 nm, from about 100 nm to about 300 nm, from about 100 nm to about 200 nm, or from about 100 nm to about 150 nm). In some embodiments, better heating is provided by larger particles and thus, in such embodiments, it may be advantageous to ensure an average particle size of about 25 nm or greater.

In some embodiments, the particles are substantially monodisperse. although the disclosure is not limited thereto. In some embodiments, the particles may exhibit a bimodal particle size distribution. In particular embodiments, the magnetic material comprises nanoparticle magnetic materials denoted as superparamagnetic materials. However, the magnetic material, in certain embodiments, can be used in the form of nanowires, nanotubes, or in the form of a sheet so long as the magnetic material is dispersed within the substrate upon production thereof.

Although any material capable of inductive heating in the presence of an alternating electromagnetic field can be used, advantageous magnetic materials include materials comprising a transition metal or a rare earth metal, particularly oxides comprising such transition metals or rare earth metals. “Rare earth metal” refers to scandium, yttrium, and the lanthanum series, as defined in the Periodic Table of Elements, or oxides thereof. Examples of rare earth metals include lanthanum, cerium, neodymium, gadolinium, yttrium, praseodymium. samarium, hafnium, and mixtures thereof. Examples of transition metals that could be used as a component of the magnetic materials include tungsten, manganese, iron, cobalt, nickel, copper, and zinc. Mixtures of transition metals and rare earth metals can be used in the same magnetic material. The oxide forms of many magnetic metals are particularly advantageous for use in the present disclosure, as metal oxides tend to be highly stable at the operating temperatures often associated with catalyst systems used to treat emissions from engines. In certain embodiments, the magnetic material associated with the catalytic article comprises superparamagnetic iron oxide nanoparticles (SPION particles) or rare earth containing particulate materials comprising neodymium-iron-boron or samarium-cobalt particles. In some embodiments, the magnetic material comprises SPION particles (e.g., iron (III) oxide particles) having an average particle size of less than about 100 nm, such as about 5 nm to about 50 nm or about 10 nm to about 40 nm.

The magnetic material can be associated with the catalytic article in various ways, e.g., by admixing with the catalyst material prior to coating a substrate to give a catalyst composition comprising the magnetic material (e.g., according to methods outlined in International Patent Application Publication No. W02017/195107 to BASF Corp., which is incorporated herein by reference in its entirety) or by combining the magnetic material with a base material and forming a substrate therefrom (e.g., according to methods outlined in U.S. Prov. Pat. Appl. No. 63/087,640 to Caudle et al., filed Oct. 5, 2020, which is incorporated herein by reference in its entirety).

### Catalyst Composition—NOx Adsorber Composition

With respect to the catalyst material of the catalytic article adapted for inductive heating disclosed herein, the material generally comprises at least one component capable of adsorbing NOx at a first temperature and desorbing NOx at a second temperature (referred to herein as a “NOx adsorber composition”). also commonly referred to as a low-temperature NOx adsorber (LT-NA) composition or “passive NOx adsorber.” Such components are typically effective for storing the NOx at temperatures below 200° C., and releasing the stored NOx at higher temperatures. For purposes of the present disclosure, the NOx adsorber is suitable for adsorbing/storing NOx until a downstream SCR catalyst is at a sufficient temperature for effective conversion of the NOₓ. At such a time (as will be described more fully herein below), current can be applied to the catalytic article comprising the NOx adsorber composition to heat the NOₓ adsorber composition to a suitable temperature for the release of the NOₓ therefrom (which can then be effectively treated by a downstream SCR catalyst). For example, in some embodiments, the NOₓ adsorber composition is designed to store NOₓ at temperatures below about 180° C. (and to release the NOₓ at temperatures above about 180° C.), to store NOₓ at temperatures below about 190° C. (and to release the NOₓ at temperatures above about 190° C., to store NOₓ at temperatures below about 200° C. (and to release the NOₓ at temperatures above about 200° C., to store NOₓ at temperatures below about 210° C. (and to release the NOₓ at temperatures above about 210° C.), or to store NOx at temperatures below about 225° C. (and to release the NOₓ at temperatures above about 225° C.).

In some embodiments, the NOₓ adsorber composition is designed to store NOₓ and release the NOₓ on demand. For example, in some embodiments (e.g., during post cold-start situations), an LT-NA catalyst can become filled with NOₓ again to a certain level, and on-demand desorption can be turned on to purge this additional NOₓ out of the catalyst. Such operation can, in some embodiments, be a tool to regulate NOₓ filling level in a LT-NA catalyst to ensure enough NOₓ capacity for the next cold-start.

Several varieties of NOₓ adsorbers are known; however, NOₓ adsorber compositions generally comprise a molecular sieve comprising a platinum group metal (PGM) component.

As used herein, the term “molecular sieve,” such as a zeolite and other zeolitic framework material (e.g., isomorphously substituted material), refers to materials based on an extensive three-dimensional network of oxygen anions connected to metal atoms (such as Si, Al, etc.) in generally tetrahedral type sites and having a substantially uniform pore distribution, with the average pore size being no larger than 20 Angstroms (Å).

Molecular sieves can be differentiated mainly according to the geometry of the voids which are formed by the rigid network of the (SiO₄)/A1O₄ tetrahedra. The entrances to the voids are surrounded by rings comprising 6, 8, 10, 12 or 14 oxygen atoms comprising the 6, 8, 10, 12 or 14 (SiO₄)/A1O₄ tetrahedra which form the entrance opening. Molecular sieves are crystalline materials having rather uniform pore sizes which. depending upon the type of molecular sieves and the type and amount of cations included in the molecular sieves lattice, range from about 3 to 10 Å in diameter. The phrase “8-ring” molecular sieve refers to a molecular sieves having 8-ring pore openings and double-six ring secondary building units and having a cage like structure resulting from the connection of double six-ring building units by 4 rings. Molecular sieves comprise small pore. medium pore and large pore molecular sieves or combinations thereof. The pore sizes are defined by the ring size.

A small pore molecular sieve contains channels defined by up to eight tetrahedral atoms. As used herein, the term “small pore” refers to pore openings which are smaller than about 5 Angstroms, for example on the order of −3.8 Angstroms. Exemplary small pore molecular sieves include framework types ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON, and mixtures or intergrowths thereof.

A medium pore molecular sieve contains channels defined by ten-membered rings. Exemplary medium pore molecular sieves include framework types AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN, and mixtures or intergrowths thereof.

A large pore molecular sieve contains channels defined by twelve-membered rings. Exemplary large pore molecular sieves include framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL4, MAZ, MEI, MOR, MOZ, MSE, MTW, NPO, OFF, OKO, OSI, RON, RWY, SAF, SAO, SBE, SBS, SBT, SEW, SFE, SFO, SFS, SFW, SOF, SOS, STO, SSF, SSY, USI, UWY, VET and mixtures or intergrowths thereof.

Typically, any framework type of molecular sieve can be used, such as framework types of ABW, ACO, AEI, AEL, AEN, AET, AFI, AFN, AFO, AFR, AFS, AFT, AFX, AFY, AHT, APC, APD, ASV, ATN, ATO, ATS, ATT, ATV, AVL, AWO, AWW, BCT, BEA, BEC, BIK, BOG, BPH, BRE, CAN, CAS, SCO, CFI, SGF, CGS, CHA, CHI, CLO, CON, CZP, DAC, DDR, DFO, DFT, DON, EAB, EDI, EEI, EMT, EON, EPI, ERI, ESV, ETR, EUO, FAU, FER, GIS, GME, GON, GOO, HEU, IFR, IFY, IHW, IRN, ISV, ITE, ITH, ITW, IWR, IWW, JBW, KFI, LAU, LEV, LOV, LTA, LTL, LTN, MAZ, MEI, MEL, MER, MFI, MFS, MON, MOR, MOZ, MTF, MTT, MTW, MWF, MWW, NAB, NAT, NES, NPO, NPT, NSI, OBW, OFF, OSI, OSO, OWE, PAR, PAU, PHI, PON, RHO, RON, RRO, RSN, RTE, RTH, RWR, RWY, SAO, SAS, SAT, SAV, SBE, SBS, SBT, SFE, SFF, SFG, SFH, SFN, SFO, SFW, SOS, SSY, STF, STI, STT, TER, THO, TON, TSC, UEI, UFI, USI, UTL, VET, VFI, VNI, VSV, WIE, WEN, YUG, ZON, or combinations thereof. For example, in certain embodiments, the molecular sieve may comprise a framework type selected from the group consisting of CHA (chabazite), FER (ferrierite), and LEV (levyne).

As used herein, the term “zeolite” refers to a specific example of a molecular sieve that includes silicon and aluminum atoms. Generally, a zeolite is defined as an aluminosilicate with an open 3-dimensional framework structure composed of comer-sharing TO₄ tetrahedra, where T is Al or Si, or optionally P. Cations that balance the charge of the anionic framework are loosely associated with the framework oxygens, and the remaining pore volume is filled with water molecules. The non-framework cations are generally exchangeable, and the water molecules removable. Aluminosilicate zeolite structures do not include phosphorus or other metals isomorphically substituted in the framework. That is, “aluminosilicate zeolite” excludes aluminophosphate materials such as SAPO, A1PO and MeAlPO materials, while the broader term “zeolite” includes aluminosilicates and aluminophosphates. For the purposes of this disclosure, SAPO, A1PO and MeAlPO materials are considered non-zeolitic molecular sieves.

A zeolite may comprise SiO₄/A1O₄ tetrahedra that are linked by common oxygen atoms to form a three-dimensional network. The molar ratio of silica-to-alumina (“SAR”) of a present zeolite can vary over a wide range, but is generally 2 or greater. For instance, a present zeolite may have a SAR of from about 5 to about 1000, such as about 10 to about 100 or about 10 to about 50 or about 15 to about 30.

The molecular sieve of the NOₓ adsorber composition is impregnated with a PGM component (i.e., the molecular sieve is a PGM component-substituted molecular sieve). As used herein, reference to impregnation with a PGM component includes all forms of association of the PGM component with the molecular sieve, such as where the PGM component resides either in the ion-exchange sites of the molecular sieve or other internal locations within the molecular sieve, or where the PGM is present on the surface of the molecular sieve, or any combination of the above-noted locations. As such, as used herein, the term “PGM-substituted” embraces the term “ion-exchanged.” As used herein, “ion-exchanged” or “PGM-exchanged” means that a PGM is supported on or in a molecular sieve material. At least some of the PGM is in ionic form, and in one or more embodiments, a portion of the PGM may be in the zero valent or metallic form or may be in the form of metal oxide aggregates. In some embodiments, the disclosed NOₓ adsorber composition is described as comprising a molecular sieve “comprising” a PGM component (or as comprising a PGM component “associated with” the molecular sieve). In such instances, “comprising” (or “associated with”) is understood to mean that the PGM component resides either in the ion-exchange sites of the molecular sieve, on the surface of the molecular sieve, or both in the ion-exchange sites and on the surface of the molecular sieve. In some embodiments, the disclosed NOₓ adsorber composition may be described as comprising a molecular sieve “containing” a PGM, and in such instances. “containing” similarly is understood to mean that the PGM resides either in the ion-exchange sites of the molecular sieve or on the surface, or both.

The term “PGM component” refers to any component that includes a PGM (e.g., ruthenium (Ru), rhodium (Rh), osmium (Os), iridium (Ir), palladium (Pd), and or platinum (Pt)). Reference to “PGM component” allows for the presence of the PGM in any valence state; however, in the context of the disclosed NOₓ adsorber compositions, the PGM is generally in a form that allows for NOₓ adsorption (e.g., including, but not limited to, ion-exchanged cation form). The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide. Certain exemplary PGM components that may find particular use in the NOₓ adsorber composition disclosed herein include palladium, platinum, rhodium, or a combination thereof. In some embodiments, the PGM component is palladium as the sole PGM component. although mixtures of PGM components could also be used. Where mixtures are employed. the PGM component can comprise two different platinum group metals, e.g., in a weight ratio of about 1:10 to about 10:1. For example, in some embodiments, the PGM component comprises platinum and palladium.

The molecular sieve of the NOₓ adsorber composition as disclosed herein has at least 1% by weight of the amount of PGM located inside the pores of the molecular sieve, for example, at least 5% by weight, further for example, at least 10% by weight, such as at least 25% by weight, and for example, at least 50% by weight of the PGM located inside the pores of the molecular sieve.

In some embodiments, the molecular sieve of the NOₓ adsorber composition as disclosed herein may be substituted with a further metal, for example, a base metal. Thus, the molecular sieve of the NOₓ adsorber composition may comprise a molecular sieve, a PGM component and optionally a base metal. The molecular sieve may be said to contain the PGM component and optionally the base metal. The base metal may be chosen from iron (Fe), copper (Cu), manganese (Mn), chromium (Cr), cobalt (Co), nickel (Ni), zinc (Zn) and tin (Sn), as well as mixtures of two or more thereof. In some embodiments, the base metal is chosen from Fe, Cu, Co, and mixtures thereof. Alternatively, the molecular sieve may be substantially free of a base metal. In some embodiments, the molecular sieve does not comprise a base metal. In some embodiments, the NOₓ adsorber composition is substantially free of any further active metal beyond the PGM component.

The concentration of the PGM component can vary, but will typically be from about 0.01 wt. % to about 6 wt. % relative to the total dry weight of the molecular sieve. The PGM component may be present in the molecular sieve, for example, from about 0.1%, about 0.2%, about 0.5%, about 0.7%, about 0.9% or about 1.0%, to about 1.5%, about 2.0%, about 2.5%, about 3.0%, about 3.5%, about 4.0%, about 4.5%, about 5.0%, or about 6% by weight, based on the total dry weight of the molecular sieve. Weights of the PGM component are measured and reported as the metal (e.g., weight of palladium). The total dry weight of the molecular sieve includes any added/exchanged metals (i.e., palladium).

As referenced above, in some embodiments, the NOₓ adsorber catalytic composition in some embodiments includes a magnetic material to render the catalytic article capable of being inductively heated through application of an electromagnetic field. However, the NOₓ adsorber catalyst composition does not, in all embodiments, comprise a magnetic material (e.g., as a magnetic material may, instead, be associated with the substrate, as described in further detail below)

The NOₓ adsorber composition as disclosed herein may be readily prepared by processes well known in the art. The disclosed NOₓ adsorber may, in some embodiments, be prepared via an incipient wetness impregnation method. Typically, a metal precursor (e.g., a PGM component) is dissolved in an aqueous or organic solution and then the metal-containing solution is added to the material to be impregnated (e.g., molecular sieve), and which contains essentially the same pore volume as the volume of the solution that was added. Capillary action draws the solution into the pores of the material. Solution added in excess of the material pore volume causes the solution transport to change from a capillary action process to a diffusion process, which is much slower. The impregnated material can then be dried and optionally calcined to remove the volatile components within the solution, depositing the metal on the surface of the material. The maximum loading is limited by the solubility of the precursor in the solution. The concentration profile of the impregnated material depends on the mass transfer conditions within the pores during impregnation and drying.

For example, a PGM component precursor (such as, for example, palladium nitrate) may be supported on the molecular sieve by impregnation, adsorption, ion-exchange, incipient wetness, precipitation, or the like. Non-limiting examples of suitable PGM precursors include palladium nitrate, tetraammine palladium nitrate, tetraammine platinum acetate, and platinum nitrate. Alternatively, PGM colloidal dispersions as discussed above could be used. During the calcination steps, or at least during the initial phase of use of the catalyst, such compounds are converted into a catalytically active form of the metal or a compound thereof.

### Substrate

According to one or more embodiments, the substrate for the NOₓ adsorber composition may be constructed of any material typically used for preparing automotive catalysts and will typically comprise a metal or ceramic honeycomb structure. The substrate typically provides a plurality of wall surfaces upon which the catalyst composition is applied and adhered, thereby acting as a carrier for the catalyst composition.

Exemplary metallic substrates comprise heat resistant metals and metal alloys, such as titanium and stainless steel as well as other alloys in which iron is a substantial or major component. Such alloys may be chosen from nickel. chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of other metals chosen from manganese, copper, vanadium, titanium, and the like. The surface or the metal carriers may be oxidized at high temperatures, e.g., 1000° C. and higher, to form an oxide layer on the surface of the substrate, improving the corrosion resistance of the alloy and facilitating adhesion of the washcoat layer to the metal surface.

Ceramic materials used to construct the substrate comprise any suitable refractory material chosen from cordierite, mullite, cordierite-a alumina, silicon nitride, zircon mullite, spodumene, alumina-silica magnesia, zircon silicate, sillimanite, magnesium silicates, zircon, petalite, a alumina, aluminosilicates and the like.

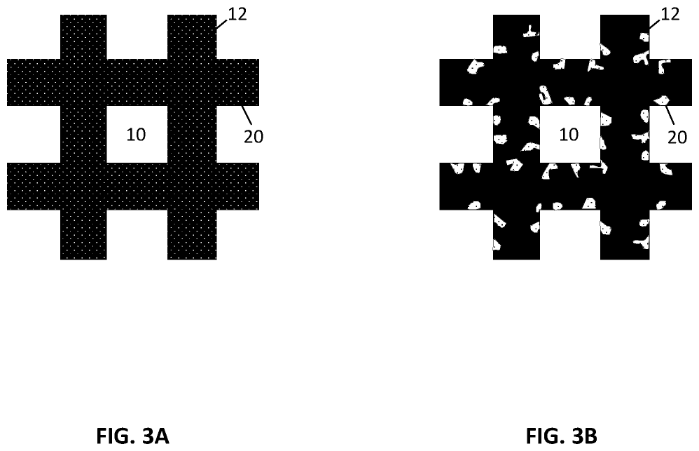

In some embodiments, as referenced above, the magnetic material associated with the catalytic article is included within the substrate itself. In some such embodiments, a magnetic material can be combined with a composition (e.g., solution or slurry) of base material precursor (e.g., ceramic precursor). The magnetic material is typically (although not always) in the form of particulate material. The combining may include mixing, milling, shaking, or the like to promote dispersion of the magnetic material throughout. The resulting mixture is formed into a substrate (e.g., via extrusion or pouring into a mold, followed by calcination and drying). General methods for producing ceramic substrates are known and are described, for example, in U.S. Pat. Nos. 5,314,650; 5,403,787; 6,455,124; 8,673,206; and 9,808,794, all to Coming, Inc., which are incorporated herein by reference in their entireties. In other embodiments, the magnetic material can be introduced into the pores of a pre-formed catalyst substrate. FIGS. 3A and 3B provide schematic drawings of substrate cross-sections illustrating two non-limiting catalyst substrates with magnetic material incorporated therein. As shown, the exemplary substrates include flow passages 10 formed by walls 12 which extend through the substrate from an upstream to downstream end, where the magnetic material 20 is dispersed within the walls 12 or dispersed within pores in the walls 12. In FIG. 3A, the black depicts the material of the substrate and the white dots represent the magnetic material; in FIG. 3B, the black depicts the base material, the white irregular portions indicate pores within the base material, and the black dots therein represent the magnetic material. See further detail provided in U.S. Prov. Pat. Appl. No. 63/087,640 to Caudle et al., filed Oct. 5, 2020, which is incorporated herein by reference in its entirety.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape chosen from trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 cpsi to 600 cpsi. The wall thickness of flow-through substrates can vary, with a typical range being between 0.002 inches and 0.1 inches. A representative commercially-available flow-through substrate is a cordierite substrate having 400 cpsi and a wall thickness of 6 mil, or 600 cpsi and a wall thickness of 4 mil. However, it will be understood that the disclosed subject matter is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 cpsi to 400 epsi and more typically about 200 cpsi to about 300 cpsi. The cross-sectional shape of the cells can vary as described above. Wall-flow substrates typically have a wall thickness between 0.002 inches and 0.1 inches. A representative commercially available wall-flow substrate is constructed from a porous cordierite, an example of which has 200 epsi and 10 mil wall thickness or 300 cpsi with 8 mil wall thickness, and wall porosity between 40-70%. Other ceramic materials such as aluminum-titanate, silicon carbide and silicon nitride can also be used as wall-flow filter substrates. However, it will be understood that the disclosed subject matter is not limited to a particular substrate type, material, or geometry. Note that where the substrate is a wall-flow substrate, the catalyst composition associated therewith (e.g., a CSF composition) can permeate into the pore structure of the porous walls (i.e., partially or fully occluding the pore openings) in addition to being disposed on the surface of the walls.

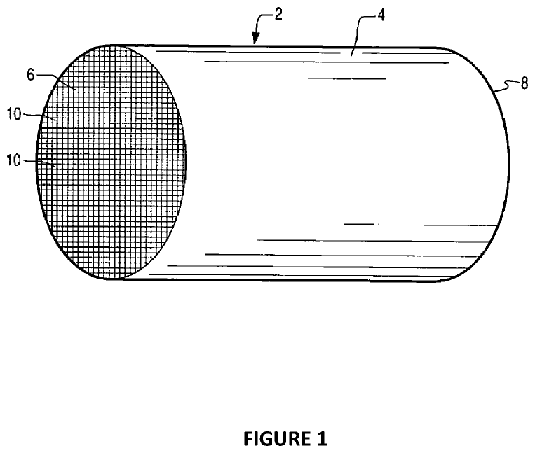

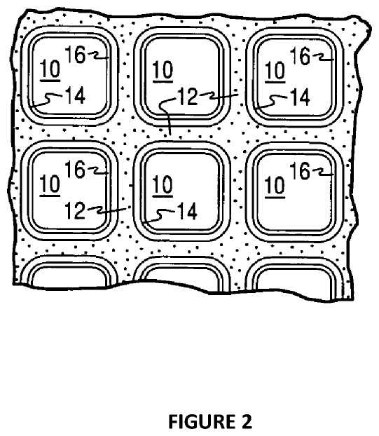

FIGS. 1 and 2 illustrate an exemplary substrate 2 in the form of a flow-through substrate coated with a washcoat composition as described herein. Referring to FIG. 1, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 2. flow passages 10 are formed by walls 12 and extend through carrier 2 from upstream end face 6 to downstream end face 8, the passages 10 being unobstructed to permit the flow of a fluid, e.g., a gas stream, longitudinally through carrier 2 via gas flow passages 10 thereof. As more easily seen in FIG. 2, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. The present disclosure can be practiced with one or more (e.g., 2, 3, or 4) catalyst layers and is not limited to the two-layer embodiment illustrated in FIG. 2.

In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. The total loading of the catalyst composition (including catalytic metal and support material) on the catalyst substrate, such as a monolithic flow-through substrate. is typically from about 0.5 g/in³ to about 6 g/in³, andfor example, from about 1 g/in³ to about 5 g/in³. Total loading of the PGM or base metal component without support material is typically in the range of about 5 g/ft³ to about 200 g/ft³ (e.g., 10 g/ft³ to about 100 g/ft³). It is noted that these weights per unit volume are typically calculated by weighing the catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed.

In some embodiments, the amount of PGM component in the NOₓ adsorber composition provided herein can be expressed as weight per unit volume of substrate. For example, in certain embodiments, the amount of PGM component in the NOₓ adsorber composition is about 10 g/ft³ to 140 g/ft³ or about 40 g/ft³ to about 100 g/ft³ (based on the volume of an underlying substrate upon which the catalyst is disposed).

The NOₓ adsorber composition is generally present on a substrate at a concentration of, for instance, from about 0.3 g/in³ to 5.5 g/in³, or from about 0.4 g/in³, about 0.5 g/in³, about 0.6 g/in³, about 0.7 g/in³, about 0.8 g/in³, about 0.9 g/in³ or about 1.0 g/in³ to about 1.5 g/in³, about 2.0 g/in³, about 2.5 g/in³, about 3.0 g/in³, about 3.5 g/in³, about 4.0 g/in³, about 4.5 g/in³, about 5.0 g/in³ or about 5.5 g/in³, based on the volume of the substrate.

### Substrate Coating Process

The catalyst composition can be used in the form of a packed bed of powder, beads, or extruded granules. However, in certain advantageous embodiments, the catalyst composition is coated on a substrate. The catalyst composition can be mixed with water (if in dried form) to form a slurry for purposes of coating a catalyst substrate. In addition to the catalyst particles, the slurry may optionally contain alumina as a binder, associative thickeners, and/or surfactants (including anionic, cationic, non-ionic or amphoteric surfactants). In some embodiments, the pH of the slurry can be adjusted, e.g., to an acidic pH of about 3 to about 5.

When present, an alumina binder is typically used in an amount of about 0.02 g/in³ to about 0.5 g/in³. The alumina binder can be, for example, chosen from boehmite, gamma-alumina, or delta/theta alumina.

The slurry can be milled to enhance mixing of the particles and formation of a homogenous material. The milling can be accomplished in a ball mill, continuous mill, or other similar equipment, and the solids content of the slurry may be, e.g., about 20 wt. %-60 wt. %, more particularly about 30 wt. %-40 wt. %. In one embodiment, the post-milling slurry is characterized by a D90 particle size of about 10 microns to about 50 microns (e.g., about 10 microns to about 20 microns). The D90 is defined as the particle size at which about 90% of the particles have a finer particle size.

The slurry is then coated on the catalyst substrate using a washcoat technique known in the art. As used herein, the term “washcoat” has its usual meaning in the art of a thin, adherent coating of a material applied to a substrate, such as a honeycomb flow-through monolith substrate or a filter substrate which is sufficiently porous to permit the passage therethrough of the gas stream being treated. As used herein and as described in Heck, Ronald and Robert Farrauto, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can have unique chemical catalytic functions.

In some embodiments, the substrate is dipped one or more times in the slurry or otherwise coated with the slurry. Thereafter, the coated substrate is dried at an elevated temperature (e.g., 100° C.-150° C.) for a period of time (e.g., 1 hour-3 hours) and then calcined by heating, e.g., at 400° C.-600° C., typically for about 10 minutes to about 3 hours. Following drying and calcining, the final washcoat coating layer can be viewed as essentially solvent-free.

After calcining, the catalyst loading can be determined through calculation of the difference in coated and uncoated weights of the substrate. As will be apparent to those of skill in the art, the catalyst loading can be modified by altering the slurry rheology. In addition, the coating/drying/calcining process can be repeated as needed to build the coating to the desired loading level or thickness.

The catalyst composition can be applied as a single layer or in multiple layers. A catalyst layer resulting from repeated washcoating of the same catalyst material to build up the loading level is typically viewed as a single layer of catalyst. In another embodiment, the catalyst composition is applied in multiple layers with each layer having a different composition. Additionally, the catalyst composition can be zone-coated, meaning a single substrate can be coated with different catalyst compositions in different areas along the gas effluent flow path.

Where the magnetic material is incorporated within the catalyst composition, it can be added to the catalyst composition prior to coating the substrate. For example, magnetic materials are conveniently added to the washcoat slurry, such as prior to the milling step such that the milling action will enhance dispersion of the magnetic material throughout the slurry.

### Emission Treatment System

The present disclosure also provides an emission treatment system that incorporates the catalyst composition or article described herein. The catalytic articles disclosed herein are typically used in an integrated emissions treatment system comprising one or more additional components for the treatment of gasoline or diesel exhaust gas emissions. As such, the terms “exhaust stream”, “engine exhaust stream”, “exhaust gas stream” and the like refer to the engine effluent as well as to the effluent downstream of one or more other catalyst system components as described herein.

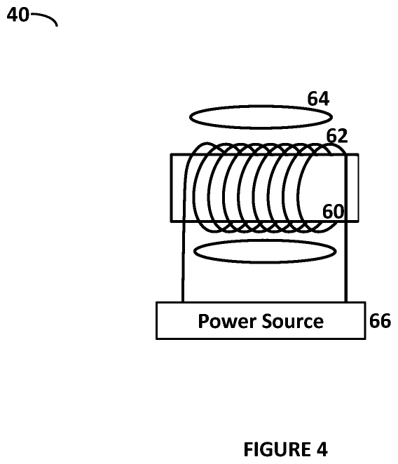

FIG. 4 shows a NOₓ adsorber catalytic article of the present disclosure adapted for inductive heating 40. As shown, the adapted catalytic article comprises a catalytic article 60 (comprising a NOₓ adsorber composition as described herein above associated with a substrate), wherein catalytic article 60 comprises a magnetic material within the substrate itself and/or associated with the catalyst composition thereon. An electric coil 62 surrounds catalytic article 60 in order to provide an alternating magnetic field 64 adapted for inductive heating of the magnetic material associated with catalytic article 60. The electric coil 62 is electrically connected to a power source 66 capable of providing alternating electric current to the coil, with output power typically in the range of about 5 kW to 50 kW and at a frequency of about 100 kHz-10000 KHz.

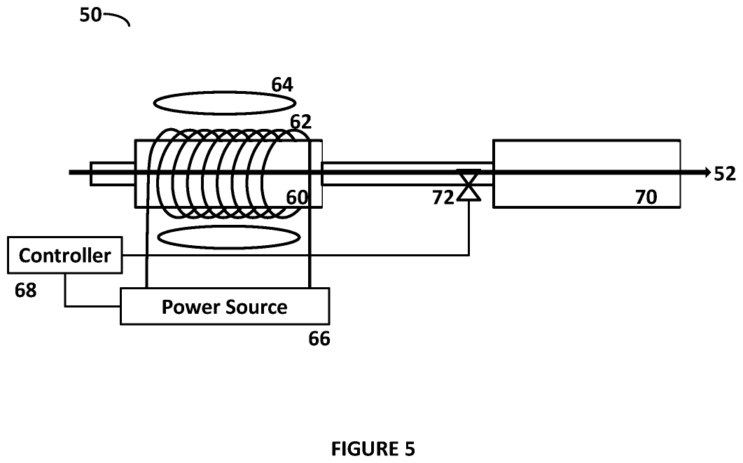

One exemplary emissions treatment system is illustrated in FIG. 5, which depicts a schematic representation of an emission treatment system 50, wherein arrow 52 shows the direction of travel of an engine effluent (typically containing gaseous pollutants, including NOₓ and particulate matter). As shown, the system comprises a catalytic article as disclosed herein 60 (comprising a NOₓ adsorber composition on a substrate), adapted for inductive heating. The system 50 further includes a downstream SCR catalyst 70, in fluid communication with catalytic article 60. The composition of the downstream SCR catalyst can vary and can comprise any components for the reduction of NOₓ. Certain SCR compositions comprise a metal-promoted molecular sieve material (e.g., copper- or iron-promoted zeolites) as described, e.g., in U.S. Pat. Nos. 4,544,538 to Zones and 6,709,644 to Zones, as well as U.S. Pat. No. 8,883,119 to Bull et al., which are herein incorporated by reference in their entireties. However, the SCR composition is not limited thereto, and can alternatively comprise, e.g., a mixed metal oxide composition (e.g., vanadia/titania); in one embodiment, it may comprise a ceria support containing niobia and base metal oxide dopants as disclosed. e.g., in International Patent Application Publication No. WO2019/069232 to BASF Corp., which is incorporated herein by reference in its entirety.

SCR catalyst 70 generally is effective to catalyze the reduction of NOₓ in the presence of a reductant, for example ammonia or urea. In operation, the reductant is typically periodically metered into the exhaust stream from a position upstream of the SCR article via an injector is in fluid communication with and upstream of the SCR article (not shown). The injector may also be associated with a reductant reservoir and a pump. Ammonia is a typical reductant for SCR reactions for treating exhaust of stationary power plants while urea is the typical SCR reducing agent used for treatment of exhaust of mobile emissions sources. Urea decomposes to ammonia and carbon dioxide prior to contact with or on the SCR catalyst, where ammonia serves as the reducing agent for NOₓ.

An electric coil 62 surrounds catalytic article 60 in order to provide an alternating magnetic field 64 adapted for inductive heating of the magnetic material associated with catalytic article 60. The electric coil 62 is electrically connected to a power source 66 capable of providing alternating electric current to the coil, with output power typically in the range of about 5 kW to 50 kW and at a frequency of about 100 kHz-10000 kHz. The system further includes an optional temperature sensor 72 positioned to measure the temperature of engine effluent gases entering the SCR catalyst 70. Both the power source 66 and the temperature sensor 72 are operatively connected to a controller 68, which is configured to control the power source and receive the temperature signals from the sensor. As would be understood, the controller 68 can comprise hardware and associated software adapted to allow the controller to provide instructions to the power source to energize the electric coil 66 at any time when inductive heating of the magnetic material is desired. The controller can select the time period for inductive heating based on a variety of factors, such as based on a particular temperature set point associated with the temperature sensor 72, at specific time period based on ignition of the engine (e.g., a control system adapted to inductively heat the magnetic material for a set time period following engine ignition), or at specific preset time intervals.

Advantageously, the controller can inductively heat catalytic article 60 once temperature sensor 72, associated with SCR catalyst 70, is at sufficient temperature for conversion of NOₓ, such that the NOₓ can be desorbed from catalytic article 60 and effectively treated by the SCR catalyst 70. The temperature at which SCR catalyst 70 is effective (which is generally the pre-determined temperature sensed at sensor 72 at which inductive heating of catalytic article 60 is triggered, releasing the NOₓ for treatment) can vary, depending upon the exact SCR catalyst composition employed. In some embodiments, however, this pre-determined temperature can be about 180° C. or about 200° C.

Note that the illustrated embodiment is merely one example of the disclosed subject matter, and other configurations are possible according to the present disclosure. For example, although illustrated on separate “bricks,” the MX adsorber composition and the downstream SCR catalyst composition may, in some embodiments be on the same brick, e.g., in a zoned configuration. In such embodiments, the electric coil 66 may encircle the whole or only a portion of the brick (e.g., just the portion of the brick on which the NOₓ adsorber composition is deposited).

In some embodiments, the emission treatment system further comprises one or more of a second selective catalytic reduction (SCR) catalyst, an SCR catalyst coated on a particulate filter (SCRoF), an ammonia or ammonia precursor injection component, a diesel oxidation catalyst (DOC), a catalyzed soot filter (CSF), or an ammonia oxidation (AMOₓ) catalyst.

A DOC or CSF catalyst typically comprises one or more PGM components impregnated on a metal oxide support such as alumina, optionally further including an oxygen storage component (OSC) such as ceria or ceria/zirconia, and typically provides oxidation of both hydrocarbons and carbon monoxide.

An LNT catalyst generally contains one or more PGM components impregnated on a support and NOₓ trapping components (e.g., ceria and/or alkaline earth metal oxides). An LNT catalyst is capable of adsorbing NOₓ under lean conditions and reducing the stored NOₓ to nitrogen under rich conditions.

An SCR catalyst is adapted for catalytic reduction of nitrogen oxides with a reductant in the presence of an appropriate amount of oxygen. Reductants may be, for example, hydrocarbon, hydrogen, and/or ammonia. SCR catalysts typically comprise a molecular sieve (e.g., a zeolite) ion-exchanged with a promoter metal such as copper or iron, with exemplary SCR catalysts including FeBEA, FeCHA and CuCHA.

A TWC catalyst refers to the function of three-way conversion where hydrocarbons, carbon monoxide, and nitrogen oxides are substantially simultaneously converted. Typically, a TWC catalyst comprises one or more platinum group metals such as palladium and/or rhodium and optionally platinum, and an oxygen storage component. Under rich conditions, TWC catalysts typically generate ammonia.

An AMOₓ catalyst refers to an ammonia oxidation catalyst, which is a catalyst containing one or more metals suitable to convert ammonia, and which is generally supported on a support material such as alumina or titania. An exemplary AMOₓ catalyst comprises a copper zeolite in conjunction with a supported platinum group metal (e.g., platinum impregnated on alumina).

Methods of making such catalyst compositions often involve impregnation of a porous support with a PGM or base metal solution and/or an ion-exchange process of molecular sieves with a metal precursor solution. Such methods and others known for making catalyst compositions that can be used within systems in conjunction with the disclosed NOₓ adsorbing catalyst provided herein are generally known in the art, e.g., as described in U.S. Pat. No. 9,138,732 to Bull et al and U.S. Pat. No. 8,715,618 to Trukhan et al., which are incorporated by reference therein in their entireties.

While the subject matter herein disclosed has been described by means of specific embodiments and applications thereof, numerous modifications and variations could be made thereto by those skilled in the art without departing from the scope of the disclosure set forth in the claims. Furthermore, various aspects of the disclosed subject matter may be used in other applications than those for which they were specifically described herein.

1. A method for adsorbing and desorbing nitrogen oxides (NOₓ) from a catalyst article for treating an exhaust gas stream from a diesel engine or a lean-burn gasoline engine, comprising:
contacting the exhaust gas stream with a catalytic article, wherein the catalytic article comprises a NOₓ adsorber composition with a platinum group metal (PGM) component disposed on or impregnated in a support material, and a substrate,
wherein the NOₓ adsorber composition is effective for storing the NOₓ at temperatures below 225° C.,
wherein the catalytic article comprises a magnetic material capable of inductive heating in response to an applied alternating electromagnetic field; and
wherein the catalytic article further comprises a conductor associated therewith for receiving current and generating an alternating electromagnetic field in response thereto, and the conductor is positioned wherein the generated alternating electromagnetic field is applied to at least a portion of the magnetic material; and
intermittently energizing the conductor by passing current therethrough to generate an alternating electromagnetic field and inductively heating the magnetic material to heat the NOₓ adsorber composition to a temperature greater than 225° C. to desorb the NOₓ from the NOₓ adsorber composition.

2. The method of claim 1, wherein the conductor is adapted with a feedback control and wherein the intermittent energizing occurs only if the substrate has a temperature below 225° C.

3. The method of claim 1, further comprising contacting the exhaust gas stream with a selective catalytic reduction (SCR) catalyst composition downstream of the NOₓ adsorber composition.

4. The method of claim 3, wherein the NOₓ adsorber composition and the SCR catalyst composition are on the same substrate.

5. The method of claim 3, wherein the NOₓ adsorber composition and the SCR catalyst composition are on separate substrates.

6. The method of claim 3, further comprising:
monitoring the temperature of the SCR catalyst composition,
wherein the intermittent energizing occurs when the temperature of the SCR catalyst composition rises above a pre-determined temperature.

7. The method of claim 6, wherein the pre-determined temperature is about 180° C. or is about 200° C.

8. The method of claim 6, further comprising maintaining the NOₓ adsorber composition at a temperature greater than 225° C. so long as the SCR catalyst composition is above the pre-determined temperature.

9. The method of claim 8, further comprising removing the current when the SCR catalyst composition is below the pre-determined temperature.

10. A system for treating an exhaust gas stream from a diesel engine or a lean-burn gasoline engine, comprising:
a catalyst article comprising a NOₓ adsorber composition with a platinum group metal (PGM) component disposed on or impregnated in a support material, and a substrate,
wherein the NOₓ adsorber composition is effective for storing the NOₓ at temperatures below 225°° C.,
wherein the catalytic article comprises a magnetic material capable of inductive heating in response to an applied alternating electromagnetic field; and
a conductor for receiving current and generating an alternating electromagnetic field in response thereto, and the conductor positioned wherein the generated alternating electromagnetic field is applied to at least a portion of the magnetic material; and
an SCR catalyst composition downstream of the NOₓ adsorber composition.

11. The system of claim 10, wherein the NCR adsorber composition and the SCR catalyst composition are on the same substrate.

12. The system of claim 11, wherein the NCR adsorber composition and the SCR catalyst composition are on separate substrates.

13. The method of claim 4, further comprising:
monitoring the temperature of the SCR catalyst composition,
wherein the intermittent energizing occurs when the temperature of the SCR catalyst composition rises above a pre-determined temperature.

14. The method of claim 5, further comprising:
monitoring the temperature of the SCR catalyst composition,
wherein the intermittent energizing occurs when the temperature of the SCR catalyst composition rises above a pre-determined temperature.

15. The method of claim 7, further comprising maintaining the NOₓ adsorber composition at a temperature greater than 225° C. so long as the SCR catalyst composition is above the pre-determined temperature.
